(19) United States
(12) Patent Application Publication
(10) Pub. No.: US 2007/0076978 A1
(43) Pub. Date: Apr. 5, 2007

(54) Moving image generating apparatus, moving image generating method and program therefor

(75) Inventor: Hisayoshi Tsubaki, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/524,472

(22) Filed: Sep. 21, 2006

(30) Foreign Application Priority Data
Sep. 30, 2005 (JP) 2005-287161

(51) Int. Cl. G06K 9/36; G06K 9/00

(52) U.S. Cl. 382/276; 382/107; 382/236

(57) ABSTRACT

There is provided a moving image generating apparatus for efficiently generating a moving image that expresses a shift of still images. The moving image generating apparatus for generating a plurality of moving image composing images from the still images to generate the moving image that represents a shift of the still images has a transition data obtaining section for obtaining transition data representing how to shift the plurality of still images, an identical partial region specifying section for specifying whether or not a partial region having image content identical with each one of a plurality of preset partial regions contained in one moving image composing image exists in the still image or in another moving image composing image based on the transition data obtained by the transition data obtaining section, a motion vector calculating section for calculating motion vector representing positional difference between the partial region specified by the identical partial region specifying section as containing the partial region having the identical image content and the partial region having the image content identical with the partial region and a moving image composing image generating section for generating the moving image composing image containing the partial region expressed by the motion vector calculated by the motion vector calculating section.

### CROSS REFERENCE TO RELATED APPLICATION

The present application claims priority from a Japanese Patent Application No. 2005-287161 filed on Sep. 30, 2005, the contents of which are incorporated herein by reference.

### BACKGROUND

1. Field of the Invention

The present invention relates to a moving image generating apparatus, a moving image generating method and a program therefor. More specifically, the invention relates to a moving image generating apparatus and a moving image generating method for generating a moving image from still images and a program for the moving image generating apparatus.

2. Related Art

There has been known a system for generating moving image data in which still images are shifted one after another by adding differential data representing the shift of the still images to still image data among systems for generating and recording moving image data from a plurality of still image data provided from a customer as disclosed in Japanese Patent Laid-Open No. 2003-259303 for example. This technology enables a user to review photographic images simply even by means of a household moving image replaying apparatus such as a DVD player and a computer terminal such as a personal computer.

However, Japanese Patent Laid-Open No. 2003-259303 has disclosed no concrete technology for efficiently generating a moving image representing a shift of images. For example, Japanese Patent Laid-Open No. 2003-259303 has not disclosed any concrete technology for efficiently generating moving image data representing a shift of still images such as movement of objects in the still images, enlargement and reduction, rotation, changes of hue, fade-in and fade-out of the still images and mosaic representation of the still images.

Accordingly, it is an object of the invention to provide a moving image generating apparatus, a moving image generating method and a program therefor that are capable of solving the above-mentioned problem. This object may be achieved through the combination of features described in independent claims of the invention. Dependent claims thereof specify preferable embodiments of the invention.

### SUMMARY

According to a first aspect of the invention, there is provided a moving image generating apparatus for generating a moving image in which a plurality of still images are shifted, having a transition data obtaining section for obtaining transition data representing how to shift the plurality of still images and a moving image generating section for generating a plurality of moving image composing images from the still images based on the transition data obtained by the transition data obtaining section to generate the moving image containing the plurality of generated moving image composing images, and the moving image generating section has an identical partial region specifying section for specifying whether or not a partial region having image content identical with each one of a plurality of preset partial regions contained in one moving image composing image exists in the still image or in another moving image composing image based on the transition data obtained by the transition data obtaining section, a motion vector calculating section for calculating motion vector representing positional difference between the partial region judged by the identical partial region specifying section as containing the partial region having the identical image content and the partial region having the image content identical with the partial region and contained in the still image or the other moving image composing image based on the transition data obtained by the transition data obtaining section, and a moving image composing image generating section for generating the moving image composing image containing the partial region expressed by the motion vector calculated by the motion vector calculating section.

The moving image generating section may further include a partial region image generating section for generating the image content of the partial region judged by the identical partial region specifying section as containing no partial image having the identical image content from the still image or the other moving image composing image based on the transition data obtained by the transition data obtaining section, and the moving image composing image generating section may generate the moving image composing image containing the image contents of the partial region expressed by the motion vector calculated by the motion vector calculating section and of the partial region generated by the partial region image generating section.

The transition data obtaining section may obtain transition data representing at least part of shift region of the still image, the moving image generating section further may include a regional shift vector calculating section for calculating regional shift vector representing a positional difference between position of a shift region in one moving image composing image and position of a shift region in the still image or in another moving image composing image based on the transition data obtained by the transition data obtaining section and representing the shift of the shift region, the identical partial region specifying section may specify whether or not the partial region having image content identical with each partial region whose whole range is contained in the shift region among the plurality of preset partial regions contained in one moving image composing image exists in the still images or in the other moving image composing images based on the regional shift vector calculated by the regional shift vector calculating section and the motion vector calculation may calculate the regional shift vector calculated by the regional shift vector calculating section as a positional difference between the partial region judged by the identical partial region specifying section as containing a partial region having the identical image content and the partial region having the image content identical with the partial region and contained in the still images or the other moving image composing images as motion vector.

The transition data obtaining section may obtain transition data representing a shift of an object shifting on a background of still images or other moving image composing images, the moving image generating section may further include an object shift vector calculating section for calculating an object shift vector representing a positional difference between position of the object in one moving image composing image and position of the object in the still image or in the other moving image composing image based on the transition data obtained by the transition data obtaining section and representing the shift of the object, the identical partial region specifying section may specify whether or not a partial region having image content identical with each partial region whose whole range is contained in the object among a plurality of preset partial regions contained in one moving image composing image exists in the still image or the other moving image composing image based on the object shift vector calculated by the object shift vector calculating section and the motion vector calculating section may calculate the object shift vector calculated by the object shift vector calculating section as motion vector representing a positional difference between the partial region judged by the identical partial region specifying section as containing the partial region of the identical image content and the partial region contained in the still image or the other moving image composing image.

The identical partial region specifying section may specify whether or not a partial region having image content identical with each partial region whose whole rage is contained in the background on which the object shifts among a plurality of preset partial regions contained in one moving image composing image exists in the still image or in the other moving image composing image based on the object shift vector calculated by the object shift vector calculating section and the motion vector calculating section may zero the motion vector of the partial region specified by the identical partial region specifying section as containing the partial region having the identical image content.

The transition data obtaining section may obtain transition data representing temporal changes of a value of shift and shift direction of the object shifting on the background of the still image or the other moving image composing image and the object shift vector calculating section may calculate object shift vector representing a positional difference of the object between one moving image composing image and the other moving image composing image by temporally integrating the temporal changes of the value of shift and shift direction of the object contained in the transition data obtained by the transition data obtaining section.

The moving image generating section may generate a MPEG-coded moving image in which a plurality of still images are shifted, the identical partial region specifying section may specify whether or not a partial region having image content identical with each of a plurality of preset macro-blocks contained in one moving image composing image exists in the still image or the other moving image composing images based on the transition data obtained by the transition data obtaining section, the motion vector calculating section may calculate motion vector representing a positional difference between the macro-block judged by the identical partial region specifying section as containing the partial region of the identical partial region and the partial region having the image content identical with the macro-block and contained in the still image or in the other moving image composing image based on the transition data obtained by the id obtaining section and the moving image composing image generating section may generate a MPEG-coded moving image composing image containing the macro-block expressed by the motion vector calculated by the motion vector calculating section.

The moving image composing image generating section may include an I picture generating section for generating moving image composing images as I pictures from the still images based on transition data obtained by the transition data obtaining section and a P picture generating section for generating moving image composing images as P pictures based on the transition data obtained by the transition data obtaining section and on the I pictures generated by the I picture generating section, the identical partial region specifying section may specify whether or not a partial region having image content identical with each of a plurality of preset macro-blocks contained in one moving image composing image exists in the I picture generated by the I picture generating section based on the id obtained by the transition data obtaining section, the motion vector calculating section may calculate motion vector representing a positional difference between the macro-block judged by the identical partial region specifying section as containing a partial region having the identical image content and a partial region having the mc identical with the macro-block and contained in the I picture generated by the I picture generating section based on the transition data obtained by the transition data obtaining section and the P picture generating section may generate the moving image composing image containing the macro-block expressed by the motion vector calculated by the motion vector calculating section as the P picture.

The moving image composing image generating section may further include a B picture generating section for generating moving image composing images as B pictures based on the transition data obtained by the transition data obtaining section, the I picture generated by the I picture generating section or the P picture generated by the P picture generating section, the identical partial region specifying section may specify whether or not a partial region having image content identical with each of a plurality of preset macro-blocks contained in one moving image composing image exists in the I picture generated by the I picture generating section or in the P picture generated by the P picture generating section, the motion vector calculating section may calculate motion vector representing a positional difference between the macro-block judged by the Identical partial region specifying section as containing the partial region of the identical image content and the partial region having the image content identical with the macro-block and contained in the I picture generated by the I picture generating section or the P picture generated by the P picture generating section based on the transition data obtained by the transition data obtaining section and the B picture generating section may generate the moving image composing image containing the macro-block expressed by the motion vector calculated by the motion vector calculating section as a B picture.

The transition data obtaining section may obtain transition data representing an shift of an object shifting on a background of still images or other moving image composing images, the moving image generating section may further include an object shift vector calculating section for calculating object shift vector representing a positional difference between position of the object in the moving image composing image to be generated as a P picture and position of the object in the I picture generated by the I picture generating section based on the transition data obtained by the transition data obtaining section and representing the shift of the object, the Identical partial region specifying section specifies whether or not the partial region having the image content identical with each of macro-blocks whose whole range is contained in the object among the plurality of macro-blocks contained in the moving image composing image to be generated as the P picture exists in the I picture generated by the I picture generating section based on the object shift vector calculated by the object shift vector calculating section, the motion vector calculating section may calculate the object shift vector calculated by the object shift vector calculating section as motion vector representing a positional difference between the macro-block judged by the Identical partial region specifying section as containing the partial region of the identical image content and the partial region having the image content identical with the macro-block and contained in the I picture generated by the I picture generating section and the P picture generating section may generate the moving image composing image containing the macro-block expressed as the motion vector calculated by the motion vector calculating section as the P picture.

The object shift vector calculating section may calculate object shift vector representing a positional difference between position of the object in the moving image composing image to be generated as a B picture and position of the object in the I picture generated by the I picture generating section or in the P picture generated by the P picture generating section based on the transition data obtained by the transition data obtaining section and representing the shift of the object, the identical partial region specifying section may specify whether or not the partial region having the image content identical with each of macro-blocks whose whole range is contained in the object among a plurality of macro-blocks contained in the moving image composing image to be generated as a B picture exists in the I picture generated by the I picture generating section or in the P picture generated by the P picture generating section based on the object shift vector calculated by the object shift vector calculating section, the motion vector calculating section may calculate the object shift vector calculated by the object shift vector calculating section as motion vector representing a positional difference between the macro-block judged by the Identical partial region specifying section as containing the partial region of the identical image content and the partial region having the image content identical with the macro-block and contained in the I picture generated by the I picture generating section or in the P picture generated by the P picture generating section and the B picture generating section may generate the moving image composing image containing the macro-block expressed by the motion vector calculated by the motion vector calculating section as a B picture.

According to a second aspect of the invention, there is provided a moving image generating method for generating a moving image in which a plurality of still images are shifted, having a transition data obtaining step of obtaining transition data representing how to shift the plurality of still images and a moving image generating step of generating a plurality of moving image composing images from the still images based on the transition data obtained in the transition data obtaining step to generate the moving image containing the plurality of generated moving image composing images, wherein the moving image generating step may include an identical partial region specifying step of specifying whether or not a partial region having image content identical with each one of a plurality of preset partial regions contained in one moving image composing image exists in the still image or in another moving image composing image based on the transition data obtained in the transition data obtaining step, a motion vector calculating step of calculating motion vector representing positional difference between the partial region judged in the identical partial region specifying step as containing the partial region having the identical image content and the partial region having the image content identical with the partial region and contained in the still image or the other moving image composing image based on the transition data obtained in the transition data obtaining step, and a moving image composing image generating step of generating the moving image composing image containing the partial region expressed by the motion vector calculated in the motion vector calculating step.

According to a third aspect of the invention, there is provided a program for a moving image generating apparatus for generating a moving image in which a plurality of still images are shifted and operating the moving image generating apparatus as a transition data obtaining section for obtaining transition data representing how to shift the plurality of still images, and a moving image generating section for generating a plurality of moving image composing images from the still images based on the transition data obtained by the transition data obtaining section to generate the moving image containing the plurality of generated moving image composing images, and operating the moving image generating section as an identical partial region specifying section for specifying whether or not a partial region having image content identical with each one of a plurality of preset partial regions contained in one moving image composing image exists in the still image or in another moving image composing image based on the transition data obtained by the transition data obtaining section, a motion vector calculating section for calculating motion vector representing positional difference between the partial region judged by the identical partial region specifying section as containing the partial region having the identical image content and the partial region having the image content identical with the partial region and contained in the still image or the other moving image composing image based on the transition data obtained by the transition data obtaining section and a moving image composing image generating section for generating the moving image composing image containing the partial region expressed by the motion vector calculated by the motion vector calculating section.

It is noted that the summary of the invention described above does not necessarily describe all necessary features of the invention. The invention may also be a sub-combination of the features described above.

Thus, the invention is capable of providing the moving image generating apparatus for efficiently generating a moving image that expresses transition of still images.

### BRIEF DESCRIPTION OF THE DRAWINGS

FIG. 1 is a drawing showing one exemplary environment for using a moving image generating apparatus 100.

FIG. 2 is a block diagram showing one exemplary block configuration of the moving image generating apparatus 100 in a first embodiment.

FIG. 3 is a drawing showing one exemplary moving image data generated by a moving image generating section 214

FIG. 4 is a drawing showing another exemplary moving image data generated by the moving image generating section 214.

FIG. 5 is a block diagram showing one exemplary block configuration of the moving image generating apparatus 100 in a second embodiment.

FIG. 6 is a drawing showing one exemplary process for calculating a DCT coefficient of a macro-block containing boundary lines.

FIG. 7 is a block diagram showing one exemplary hardware configuration of the moving image generating apparatus 100.

### DESCRIPTION OF EXEMPLARY EMBODIMENTS

The invention will now be described based on preferred embodiments, which do not intend to limit the scope of the invention, but exemplify the invention. All of the features and the combinations thereof described in the embodiments are not necessarily essential to the invention.

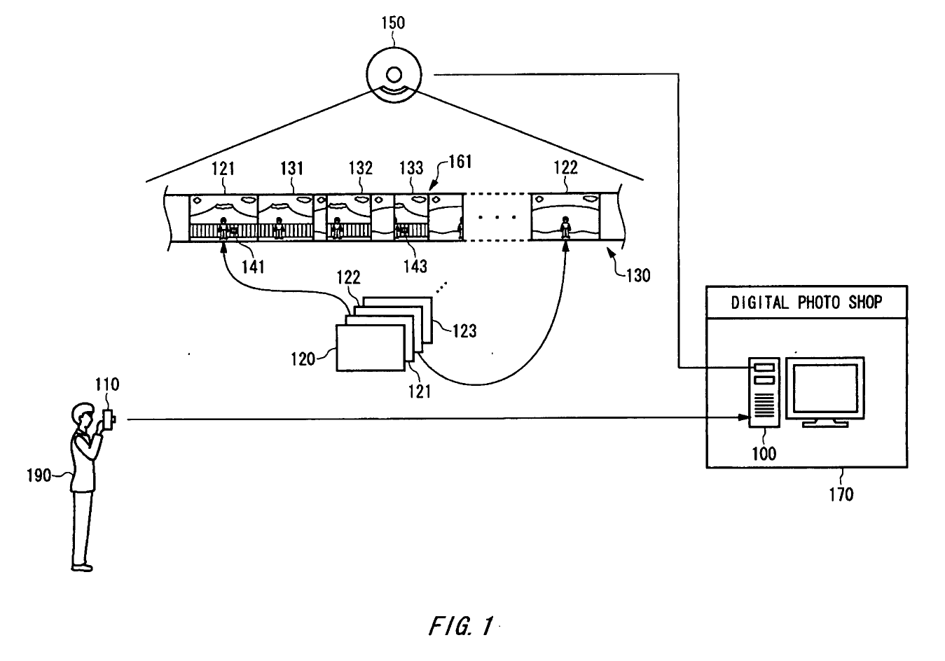

FIG. 1 is a drawing showing one exemplary environment for using a moving image generating apparatus 100 according to one embodiment. The moving image generating apparatus 100 receives still images 120, 121, 122, 123 and so on captured by a user 190 by using an image capturing apparatus 110 to generate MPEG-coded moving image data 130 such as a slide show. At this time, the moving image generating apparatus 100 generates a plurality of MPEG-coded moving image composing images that are images of each frame to be regenerated between still images by processing the still images in accordance to transition data defining transition of still images such as motion of the still images. In case of FIG. 1, the moving image generating apparatus 100 generates a moving image starting from a state in which the still image 121 is shown and showing the still image 122 that appears gradually from one end of the still image 121.

For example, the moving image generating apparatus 100 obtains transition data that represents transition from the still image 121 to the still image 122 caused by the shift of the still images 121 and 122. Then, the moving image generating apparatus 100 calculates shift rate of the still images 121 and 122 from the transition data and specifies that a macro-block within a part of region 143 of a moving image composing image 133 is identical with image content of a macro-block within a part of a region 141 of the still image 121 for example. Then, the moving image generating apparatus 100 expresses the image content of the macro-block within the region 143 as motion vector with respect to the macro-block within the region 141. In this case, the moving image generating apparatus 100 calculates shift vector by which the still image 121 has shifted as the motion vector. Thus, the moving image generating apparatus 100 can generate the MPEG-coded moving image data directly from the transition data without performing such complicated process of generating whole pixel data of an image in each frame contained in a moving image to carry out block matching.

The moving image generating apparatus 100 can also judge position of a boundary between the still images 121 and 122 in the moving image composing image 133 such as position of a boundary 161 in the moving image composing image 133 from the shift rate of the still images 121 and 122 directly from the transition data. In this case, the moving image generating apparatus 100 generates pixel data in the macro-block containing the boundary therein by combining image contents of the images 121 and 122. Then, the moving image generating apparatus 100 calculates a DCT coefficient of the macro-block containing the boundary by implementing DCT transform on the pixel data within the macro-block obtained by combining the image contents. The moving image generating apparatus 100 may also calculate the DCT coefficient of the macro-block in which the image contents of the still images 121 and 122 near the boundary are superimposed by directly adding a DCT coefficient obtained from a macro-block near the boundary of the still image 121 with a DCT coefficient obtained from a macro-block near the boundary of the still image 122.

It is noted that the moving image generating apparatus 100 may obtain instructions from a designer and the user 190 who is to create the moving image as transition data or may obtain from template data for generating moving image representing effects applied to still images such as a shift of an object as transition data. It is also noted that the moving image generating apparatus 100 may record the generated moving image in an optical recording medium such as a DVD 150 to provide to the user 190 or may provide the generated moving image to the user 190 via a communication line such as Internet. The moving image generating apparatus 100 may also receive still images from the image capturing apparatus 110 via a communication line such as Internet or may receive still images recorded in a recording medium such as a semiconductor memory. It is noted that the moving image may be captured images or may be image data, other than captured image, created by using an image processing soft and the like. It is also noted that the moving image generating apparatus 100 may be a terminal for generating a moving image installed in a digital photo shop 170 or may be a terminal such as a personal computer installed in a personal home.

As described above, the moving image generating apparatus 100 of the present embodiment can judge data of a macro-block having image content identical with a macro-block of a still image or another moving image composing image directly from transition data. Therefore, the moving image generating apparatus 100 is not necessary to generate whole pixel data of an image of each frame contained in the moving image. Accordingly, the moving image generating apparatus 100 can generate a moving image at high speed as compared to the case of applying MPEG-coding after generating pixel data of each frame contained in the moving image. For example, the moving image generating apparatus 100 can remarkably reduce a processing amount corresponding to block matching in the MPEG-coding.

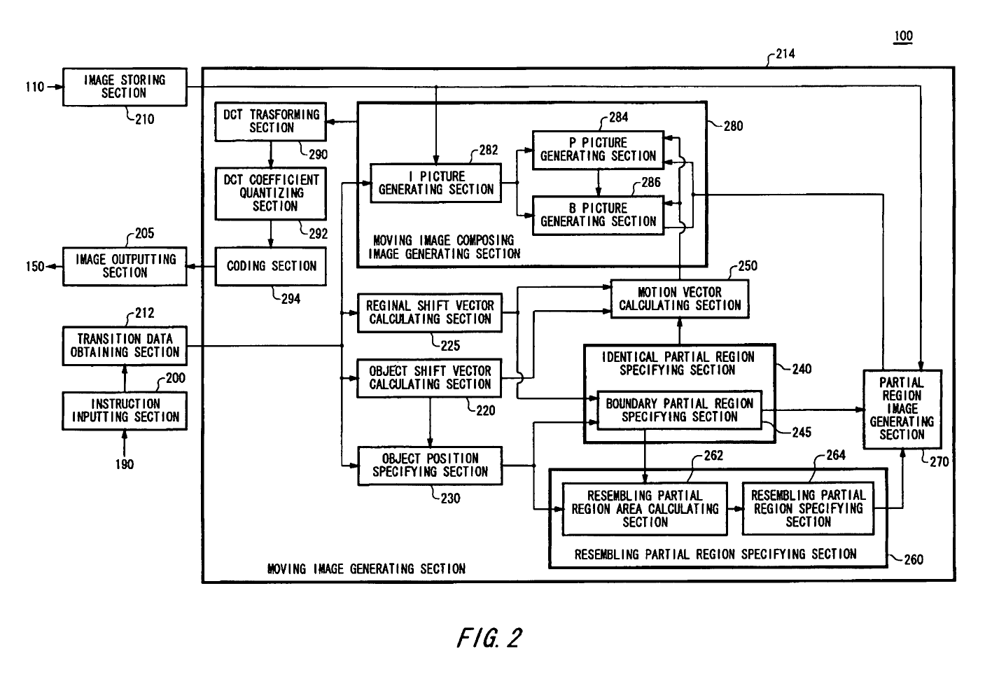

FIG. 2 is a block diagram showing one exemplary block configuration of the moving image generating apparatus 100 in a first embodiment. The moving image generating apparatus 100 of the present embodiment generates a moving image in which a plurality of still images is shifted. The moving image generating apparatus 100 comprises an instruction inputting section 200, an image outputting section 205, an image storing section 210, a transition data obtaining section 212 and a moving image generating section 214. The moving image generating section 214 has an object shift vector calculating section 220, a regional shift vector calculating section 225, an object position specifying section 230, an identical partial region specifying section 240, a motion vector calculating section 250, a resembling partial region specifying section 260, a partial region image generating section 270, a moving image composing image generating section 280, a DCT transforming section 290 a DCT coefficient quantizing section 292 and a coding section 294. The resembling partial region specifying section 260 also has a boundary partial region area calculating section 262 and a resembling partial region selecting section 264. The identical partial region specifying section 240 contains a boundary partial region specifying section 245. The moving image composing image generating section 280 contains an I picture generating section 282, a P picture generating section 284 and a B picture generating section 286.

The image storing section 210 stores a plurality of still images. The transition data obtaining section 212 obtains transition data representing how to shift the plurality of still images stored in the image storing section 210. More specifically, the transition data obtaining section 212 obtains an instruction representing how to shift the still images inputted to the instruction inputting section 200 from the user 190. Then, the moving image generating section 214 generates a plurality of moving image composing images from the still images stored in the image storing section 210 moving image composing images based on the transition data obtained through the transition data obtaining section 212 to generate a moving image containing the plurality of generated. More specifically, the moving image generating section 214 may generate a MPEG-coded moving image in which the plurality of still images stored in the image storing section 210 are shifted.

Or more specifically, the transition data obtaining section 212 obtains transition data representing a shift of at least a part of a region to be shifted or a shift region in the still image stored in the image storing section 210. Then, based on the transition data representing the shift of the shift region obtained by the transition data obtaining section 212, the regional shift vector calculating section 225 calculates regional shift vector representing a positional difference between position of a shift region in one moving image composing image and position of shift region in the still image stored in the image storing section 210 or in another moving image composing image. Then, based on the regional shift vector calculated by the regional shift vector calculating section 225, the identical partial region specifying section 240 specifies whether or not a partial region having image content identical with each partial region whose whole range is contained in the shift region, among a plurality of preset partial regions contained in one moving image composing image, exists in the still image stored in the image storing section 210 or in the other moving image composing image.

Then, the motion vector calculating section 250 calculates the regional shift vector calculated by the regional shift vector calculating section 225 as motion vector representing the positional difference between the partial region judged by the identical partial region specifying section 240 as having the partial region of the identical image content and the partial region contained in the still image stored in the image storing section 210 or the other moving image composing image having the image content identical with the partial region. Then, the moving image composing image generating section 280 generates a moving image composing image containing the partial region expressed by the motion vector calculated by the motion vector calculating section 250. Thus, the moving image composing image generating section 280 can readily specify the partial region whose image content is identical with the other moving image composing image based on the transition data.

As described above, the identical partial region specifying section 240 specifies whether or not the partial region having the image content identical with each of the plurality of preset partial regions contained in one moving image composing image exists in the still images stored in the image storing section 210 or in the other moving image composing images based on the transition data obtained by the transition data obtaining section 212. Then, the motion vector calculating section 250 calculates the motion vector representing the positional difference between the partial region judged by the identical partial region specifying section 240 as containing the partial region of the identical image content and the partial region having the image content identical with the partial region and contained in the still image stored in the image storing section 210 or the other moving image composing image based on the transition data obtained by the transition data obtaining section 212.

The operation of the identical partial region specifying section 240 will be explained more specifically. The boundary partial region specifying section 245 specifies whether or not the plurality of preset partial regions contained in one moving image composing image crosses over the boundary line of the shift region based on the regional shift vector calculated by the regional shift vector calculating section 225. Then, the identical partial region specifying section 240 judges the partial region judged by the boundary partial region specifying section 245 that it does not cross over the boundary line as the partial region in which a partial image of the identical image content exists. Still more, the identical partial region specifying section 240 judges the partial region that has been judged by the boundary partial region specifying section 245 that it crosses over the boundary line as the partial region that has been judged that it contains no partial image of the identical image content. Thus, the boundary partial region specifying section 245 specifies whether or not the plurality of preset partial regions contained in one moving image composing image crosses over the boundary line of the shift region based on the transition data presenting the shift of the shift region obtained by the transition data obtaining section 212.

Then, based on the transition data representing the shift of the shift region obtained by the transition data obtaining section 212, the partial region image generating section 270 specifies position of the shift region in the moving image composing image and based on the specified position of the shift region, generates the image content of the partial region that has been judged by the boundary partial region specifying section 245 that it crosses over the boundary line by combining the image of the shift region to be contained in the partial region that has been judged by the boundary partial region specifying section 245 to cross over the boundary line and an image of a region containing no shift region in the still image stored in the image storing section 210 or the other moving image composing image within the range of the partial region. Thus, the partial region image generating section 270 generates the image content of the partial region judged by the boundary partial region specifying section 245 as crossing over the boundary line by combining a part of the plurality of partial regions contained in the still image stored in the image storing section 210 or the other moving image composing image and an image of the shift region based on the transition data representing the shift of the shift region obtained by the transition data obtaining section 212.

The transition data obtaining section 212 also obtains transition data representing a shift of an object shifting on the background o the still images stored in the image storing section 210 and the other moving image composing images. Then, based on the transition data representing the shift of the object obtained y the transition data obtaining section 212, the object shift vector calculating section 220 calculates object shift vector representing a positional difference between position of the object in one moving image composing image and position of the object in the still image stored in the image storing section 210 or in the other moving image composing image. Then, the object position specifying section 230 specifies position of the object in the moving image composing image based on the object shift vector calculated by the 20 and the position of the object in the other moving image composing image. It is noted that the object position specifying section 230 may specify the position of the object in each of a plurality of moving image composing images.

More specifically, the transition data obtaining section 212 obtains the transition data representing temporal changes of a value of shift and shift direction of the object shifting on the background of the still images stored in the image storing section 210 or of the moving image composing images. Then, the object shift vector calculating section 220 calculates the object shift vector representing the difference of position of the object between one moving image composing image and another moving image composing image by temporally integrating the temporal changes of the value of shift and the shift direction of the object contained in the transition data obtained by the transition data obtaining section 212. Concretely, the object position specifying section 230 specifies the position of the object in the moving image composing image by temporally integrating the temporal changes of the value of shift and the shift direction of the object obtained by the transition data obtaining section 212. More specifically, the transition data obtaining section 212 obtains the transition data representing the value of shift of the object in x and y directions between respective moving image composing images to be reproduced in succession and the object shift vector calculating section 220 calculates the object shift vector by accumulatively adding the values of shift of the object in the x and y directions obtained by the transition data obtaining section 212. Thus, the object position specifying section 230 specifies the position of the object n the moving image composing image based on the transition data representing the shift of the object obtained by the transition data obtaining section 212.

Then, based on the position of the object in the moving image composing image specified by the object position specifying section 230, the boundary partial region specifying section 245 specifies whether or not a plurality of preset partial regions contained in one moving image composing image crosses over a boundary line between the object and the background still image stored in the image storing section 210 or the other moving image composing image. Thus, based on the transition data representing the shift of the object obtained by the transition data obtaining section 212, the boundary partial region specifying section 245 specifies whether or not the plurality of preset partial regions contained in one moving image composing image crosses over the boundary line between the object and the background.

Then, the identical partial region specifying section 240 judges a partial region that has been judged by the boundary partial region specifying section 245 as not crossing over the boundary line between the object and the background as a partial region containing the partial region of the identical image content. Still more, the identical partial region specifying section 240 judges a partial region that has been judged by the boundary partial region specifying section 245 as crossing over the boundary line as a partial region judged as containing no partial region having the identical image content. Then, based on the position of the object specified by the object position specifying section 230 based on the object shift vector, the identical partial region specifying section 240 specifies whether or not the partial region having the image content identical with each partial region whose whole range is contained in the object among the plurality of preset partial regions contained in one moving image composing image exists in the still image stored in the image storing section 210 or in the other moving image composing image. Then, the motion vector calculating section 250 calculates the object shift vector calculated by the object shift vector calculating section 220 as motion vector representing positional difference between the partial region judged by the identical partial region specifying section 240 as containing the partial region of the identical image content and the partial region having the image content identical with the partial region and contained in the still image stored in the image storing section 210 or the other moving image composing image.

Still more, based on the position of the object calculated by the object position specifying section 230 based on the object shift vector, the identical partial region specifying section 240 specifies whether or not the partial region having the image content identical with each partial region whose whole range is contained in the background on which the object shifts among the plurality of preset partial regions contained in one moving image composing image exists in the still image stored in the image storing section 210 or in the other moving image composing image. Then, the motion vector calculating section 250 zeros motion vector of the partial region specified by the identical partial region specifying section 240 that the partial region of the identical image content is contained in the background.

Then, the partial region image generating section 270 generates image content of the partial region judged by the boundary partial region specifying section 245 as crossing over the boundary line by combining an image contained in the partial region in the object specified from relative position of the position of the object in the moving image composing image specified by the object position specifying section 230 and the position of the partial region judged by the boundary partial region specifying section 245 as crossing over the boundary line and the background image in a region not contained in the object among background images within a range of the partial region. Thus, the partial region image generating section 270 generates the image content of the partial region judged by the boundary partial region specifying section 245 as crossing over the boundary line by combining the object and a part of the plurality of partial regions contained in the still image stored in the image storing section 210 or the other moving image composing image based on the transition data representing the shift of the object obtained by the transition data obtaining section 212.

Thus, the partial region image generating section 270 generates the image content of the partial region judged by the identical partial region specifying section 240 as containing no partial image of the identical image content from the still image stored in the image storing section 210 or the other moving image composing image based on the transition data obtained by the transition data obtaining section 212. Still more, the partial region image generating section 270 generates the image content of the partial region judged by the identical partial region specifying section 240 as not containing the partial image of the identical image content by combining a part of the plurality of partial regions contained in the still image stored in the image storing section 210 or in the other moving image composing image.

The resembling partial region specifying section 260 specifies the other moving image composing image having a partial region resembling to the image content of the partial region judged by the boundary partial region specifying section 245 as crossing over the boundary line based on the position of the object in each of the plurality of moving image composing images specified by the object position specifying section 230. In this case, the partial region image generating section 270 expresses the image content of the partial region judged by the boundary partial region specifying section 245 as crossing over the boundary line by motion vector representing positional difference between position of the partial region in one moving image composing image and position of the partial region specified by the resembling partial region specifying section 260 and by differential image between the partial region specified by the resembling partial region specifying section 260 and the partial region in one moving image composing image.

In concrete, the boundary partial region area calculating section 262 calculates, respectively, an area of the object and an area of the background contained in the partial region judged by the boundary partial region specifying section 245 as crossing over the boundary line based on the position of the object in the moving image composing image specified by the object position specifying section 230. Then, when the area of the object calculated by the boundary partial region area calculating section 262 is larger than the area of the background calculated by the boundary partial region area calculating section 262, the resembling partial region selecting section 264 selects a partial region resembling with the partial region judged by the boundary partial region specifying section 245 as crossing over the boundary line out of the other moving image composing images containing the image of the object based on the position of the object in each of the plurality of moving image composing images specified by the object position specifying section 230.

When the area of the object calculated by the boundary partial region area calculating section 262 is smaller than the area of the background calculated by the boundary partial region area calculating section 262, the resembling partial region selecting section 264 selects a partial region containing an image that is the background of the partial region judged by the boundary partial region specifying section 245 as crossing over the boundary line out of the other moving image composing images containing the image of the object based on the position of the object in each of the plurality of moving image composing images specified by the object position specifying section 230. Then, the partial region image generating section 270 expresses the image content of the partial region judged by the boundary partial region specifying section 245 as crossing over the boundary line by the motion vector representing the positional difference between the position of the partial region in one moving image composing image and the position of the partial region selected by the resembling partial region selecting section 264 as well as the differential image between the partial region selected by the resembling partial region selecting section 264 and the partial region in one moving image composing image.

Then, the moving image composing image generating section 280 generates a moving image composing image containing the partial region expressed by the motion vector calculated by the motion vector calculating section 250 and the partial region generated by the partial region image generating section 270. Still more, the moving image composing image generating section 280 generates a moving image composing image containing the image content of the partial region expressed by the motion vector calculated by the motion vector calculating section 250 and of the partial region generated by the partial region image generating section 270. Therefore, the moving image generating apparatus 100 can quickly generate the moving image composing image without searching by means of block matching by specifying a macro-block that can be expressed only by the motion vector.

In case when the moving image generating section 214 generates a MPEG-coded moving image, the identical partial region specifying section 240 specifies whether or not a partial region having image content identical with each of a plurality of preset macro-blocks contained in one moving image composing image exists in the still images stored in the image storing section 210 or in the other moving image composing images based on the transition data obtained by the transition data obtaining section 212. Then, the motion vector calculating section 250 calculates a motion vector representing a positional difference between the macro-block judged by the identical partial region specifying section 240 as containing the partial region having the identical image content and the partial region having the image content identical with the macro-block and contained in the still images stored in the image storing section 210 or in the other moving image composing images based on the transition data obtained by the transition data obtaining section 212. Still more, the partial region image generating section 270 generates image content of the macro-block judged by the identical partial region specifying section 240 as containing no partial image of the identical image content by combining a part of the plurality of partial regions contained in the still images stored in the image storing section 210 or in the other moving image composing images based on the transition data obtained by the transition data obtaining section 212. Then, the moving image composing image generating section 280 generates a moving image composing image containing the macro-block expressed by the motion vector calculated by the motion vector calculating section 250 and the macro-block generated by the partial region image generating section 270.

The I picture generating section 282 also generates a moving image composing image as I picture from the still image stored in the image storing section 210 based on the transition data obtained by the transition data obtaining section 212. Then, the P picture generating section 284 generates a moving image composing image as P picture based on the transition data obtained by the transition data obtaining section 212 and the I picture generated by the I picture generating section 282. Then, the identical partial region specifying section 240 specifies whether or not a partial region having the image content identical with each of a plurality of preset macro-blocks contained in one moving image composing image exists in the I picture generated by the I picture generating section 282 based on the transition data obtained by the transition data obtaining section 212.

Then, the motion vector calculating section 250 calculates motion vector representing a positional difference between the macro-block judged by the identical partial region specifying section 240 as containing the partial region of the identical image content and a partial region contained in the I picture generated by the I picture generating section 282 and having the image content identical with the macro-block base don the transition data obtained by the transition data obtaining section 212. Then, the P picture generating section 284 generates the moving image composing image containing the macro-block expressed by the motion vector calculated by the motion vector calculating section 250 and the macro-block generated by the partial region image generating section 270 as the P picture. The B picture generating section 286 also generates a moving image composing image as B picture based on the transition data obtained by the transition data obtaining section 212 and the I picture generated by the I picture generating section 282 or the P picture generated by the P picture generating section 284.

In concrete, the identical partial region specifying section 240 specifies whether or not the partial region having the image content identical with each one of a plurality of preset macro-blocks contained in one moving image composing image exists in the I picture generated by the I picture generating section 282 or the P picture generated by the P picture generating section 284 based on the transition data obtained by the transition data obtaining section 212. Then, the motion vector calculating section 250 calculates motion vector representing a positional difference between the macro-block judged by the identical partial region specifying section 240 as containing the partial region of the identical image content and the partial region having the image content identical with the macro-block and contained in the I picture generated by the I picture generating section 282 or the P picture generated by the P picture generating section 284 based on the transition data obtained by the transition data obtaining section 212. The B picture generating section 286 generates a moving image composing image containing the macro-block expressed by the motion vector calculated by the motion vector calculating section 250 and the macro-block generated by the partial region image generating section 270 as the B picture.

In case when the transition data obtaining section 212 obtains transition data representing a shift of an object shifting on a background of the still images stored in the image storing section 210 or of the other moving image composing images, the object shift vector calculating section 220 calculates object shift vector representing a positional difference between the position of the object in the moving image composing image to be generated as the P picture and the position of the object in the I picture generated by the I picture generating section 282 based on the transition data obtained by the transition data obtaining section 212 and representing the shift of the object.

Then, the identical partial region specifying section 240 specifies whether or not a partial region having image content identical with each one of macro-blocks whose whole range is contained in the object among the plurality of macro-blocks contained in the moving image composing image to be generated as the P picture exists in the I picture generated by the I picture generating section 282 based on the object shift vector calculated by the object shift vector calculating section 220. Then, the motion vector calculating section 250 calculates the object shift vector calculated by the object shift vector calculating section 220 as motion vector representing a positional difference between the macro-block judged by the identical partial region specifying section 240 as containing the partial region of the identical image content and the partial region having the image content identical with the macro-block and contained in the I picture generated by the I picture generating section 282. Then, the P picture generating section 284 generates a moving image composing image containing the macro-block expressed by the motion vector calculated by the motion vector calculating section 250 and the macro-block generated by the partial region image generating section 270 as the P picture.

The object shift vector calculating section 220 also calculates the object shift vector representing a positional difference between the position of the object in the moving image composing image to be generated as the B picture and the position of the object in the I picture generated by the I picture generating section 282 or in the P picture generated by the P picture based on the transition data obtained by the transition data obtaining section 212 and representing the shift of the object. Then, the identical partial region specifying section 240 specifies whether or not the a partial region having image content identical with each one of the macro-blocks whose whole range is contained in the object among the plurality of macro-blocks contained in the moving image composing image as the B picture exists in the I picture generated by the I picture generating section 282 or the P picture generated by the P picture generating section 284 based on the object shift vector calculated by the object shift vector calculating section 220. Then, the motion vector calculating section 250 calculates the object shift vector calculated by the object shift vector calculating section 220 as motion vector representing a positional difference between the macro-block judged by the identical partial region specifying section 240 as containing the partial region of the identical image content and the partial region having the image content identical with the macro-block and contained in the I picture generated by the I picture generating section 282 or the P picture generated by the P picture generating section 284. Then, the B picture generating section 286 generates the moving image composing image containing the macro-block expressed by the motion vector calculated by the motion vector calculating section 250 and the macro-block generated by the partial region image generating section 270 as the B picture.

The DCT transforming section 290 calculates implements DCT transform on the moving image composing image generated by the moving image composing image generating section 280 as the I picture, P picture or B picture to calculate a DCT coefficient. The DCT coefficient quantizing section 292 implements quantization on the DCT coefficient calculated by the DCT transforming section 290 to generate a moving image composing image whose data amount is compressed. The coding section 294 implements coding on the moving image composing image generated by the DCT coefficient quantizing section 292 to generate a moving image containing the moving image composing images whose data amount has been compressed. In concrete, the coding section 294 may implement run length coding or Huffman coding on the moving image composing image. The image outputting section 205 outputs a moving image containing the moving image composing images generated by the coding section 294 to the outside of the moving image generating apparatus 100. For instance, the image outputting section 205 outputs the moving image to a recording medium such as a DVD.

As described above, the moving image generating apparatus 100 of the present embodiment can directly calculate the motion vector from the transition data representing the shift of the object and others. The moving image generating apparatus 100 can also calculate a DCT coefficient and can obtain a differential image signal directly from transition data for macro-blocks at the contour of an object. Therefore, the moving image generating apparatus 100 generates a moving image at high speed as compared to the case of implementing MPEG-coding after processing still images and generating pixel data of moving image composing images. It is noted that the still image in the present embodiment may be an image composing animation and may be a partial image in one image composing the animation such as an image of an object contained in the animation. Then, the moving image generating apparatus 100 may generate the animation from those plurality of still images. It is needless to say that the moving image generating apparatus 100 can generate the animation at high speed as compared to implementing MPEG-coding after generating pixel data of images composing the animation also in this case.

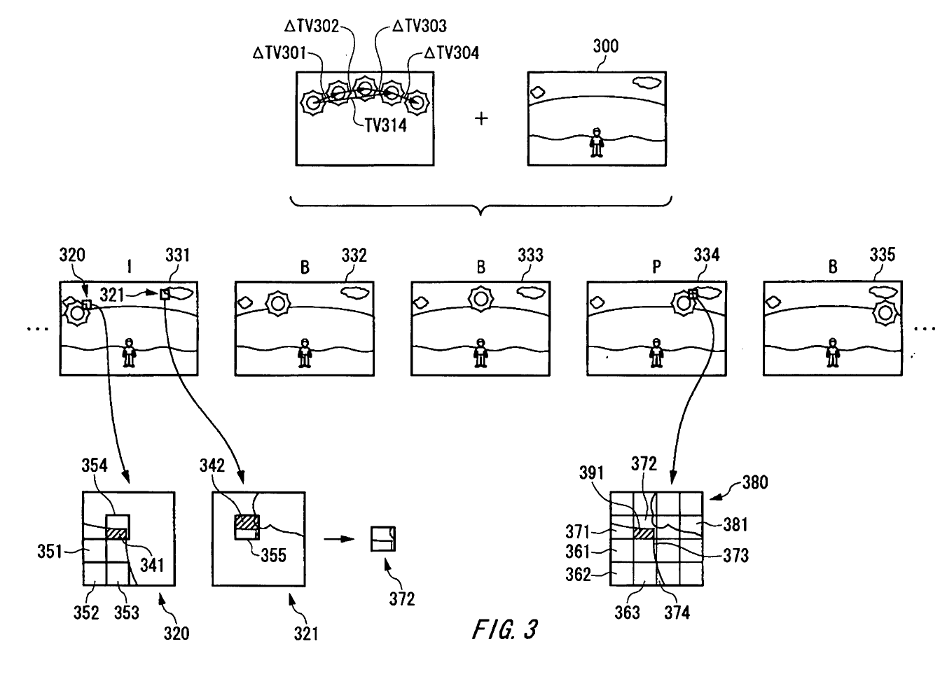

FIG. 3 is a drawing showing one exemplary moving image data generated by the moving image generating section 214. In case of this figure, the moving image generating apparatus 100 generates moving image data showing a shift of an object representing the sun on the background of a still image 300. The transition data obtaining section 212 obtains differences of coordinates of the object representing the sun (vectors ΔTV 301, 302, 303 and 304) between the moving image composing images reproduced in succession as transition data. The transition data also includes initial position of the object and the moving image generating section 214 generates a moving image composing image 331 by superimposing an image of the subject on the initial position of the object indicated by the transition data of the still image 300. At this time, the moving image generating apparatus 100 generates the moving image composing image 331 as I picture.

Then, in calculating a moving image composing image 334 (P picture), the object shift vector calculating section 220 calculates object shift vector V314 representing a positional difference between the moving image composing images by sequentially adding each vector ΔTV shown by the transition data from the moving image composing image 331 (I picture). In case of this figure, the object shift vector TV314 may be expressed by TV301+ΔTV302+ΔTV303. Beside that, the transition data obtaining section 212 may obtain time-dependent data of speed of the object or may calculate the object shift vector by which the object has shifted by temporal integration from the I picture. In either case, the method for calculating the object shift vector is the temporal integration of the positional change of the object.

Macro-blocks 371, 372, 373 and 374 containing the contour of the object may be specified from the position of the object in the moving image composing image 334 (P picture), information on contour of the object and the position of the macro-block. Then, macro-blocks 361, 362 and 363 whose whole range is contained in the object in a region 380 in the vicinity of the boundary portion between the object and the background in the moving image composing image 334 (P picture) have the image content identical with partial regions 351, 352 and 353, respectively, in the I picture at the position where the object shift vector TV314 is shifted backward.

Still more, the macro-blocks 371, 372, 373 and 374 containing the contour of the object may be specified from the position of the object in the moving image composing image 334 (P picture), contour information of the object and the position of the macro-blocks. Then, whole regions of macro-blocks (such as a macro-block 381) existing around the object of the macro-blocks 371, 372, 373 and 374 including the contour of the object are contained in the background. Image content of the macro-blocks whose whole region is contained in the background is identical with the image content (image of the background) of the I picture in the range of that macro-block so long as the object is not contained in the range of the macro-block in the I picture. Accordingly, the image content of the macro-block whose whole region is contained in the background may be expressed by motion vector of zero and by a differential image signal of zero.

The macro-blocks containing the contour of the object (such as the macro-block 372) is generated by combination of the background image with the object. For example, combination of the image of the object of a region 391 containing the object in the macro-block 372 (part of the image 341 in the moving image composing image 331 for example) with an image of a region 342 other than a region 391 of the object in the image content in the range shown by the macro-block 372 in the I picture enables the image of the macro-block 372 to be generated.

The moving image generating section 214 may express the image content of the macro-block 372 by using the differential image and motion vector. For example, the moving image generating section 214 may calculate an area of the region 391 of the object and when the area of the region 391 to an area of the macro-block is greater than a reference area set in advance, may generate a differential image signal from a partial region 354 of the moving image composing image 331 (I picture) to generate the image content of the macro-block 372 by the generated differential image signal and the ob between the macro-block. When the area of the region 391 to the area of the macro-block is less than the preset reference area, the moving image generating section 214 may express the image content of the macro-block 372 by generating the differential image signal from the partial region 355 of the moving image composing image 331 (I picture) of the position of the macro-block 372 and by zeroing the generated differential image signal and the motion vector. Thus, the moving image generating apparatus 100 can readily specify the resembling partial region based on the transition data without implementing the block matching.

As described above, the moving image generating apparatus 100 can readily specify an image whose image content is identical by adding shift information of an object that can be represented by the transition data. Therefore, the moving image generating apparatus 100 can quickly generate MPEG-compressed moving image as compare to generating pixel data of the moving image composing images once. Specifically, since the moving image generating apparatus 100 can realize the process, equivalent to the block matching, for calculating the motion vector by adding the shift information of the object, it can calculate the motion vector more quickly. It is noted that in the shift of the object represented by the transition data, a difference of position of the object in a reference moving image composing image (I picture for example) from position of the object in another moving image composing image (B picture and P picture) is desirable to be a value whose minimum unit ½ pixel. Since the motion vector in the MPEG-coding is identical with the object shift vector in a macro-block and differential data may be expressed as zero in this case, a moving image may be compressed by higher compression rate and a moving image may be generated more quickly.

It is noted that although the shift of the object has been exemplified in the explanation in the figure, the transition data may be a shift of a part of region contained in a still image (I picture). A moving image may be generated quickly also in this case by shifting the region based on the transition data by the similar method explained in connection with FIG. 3.

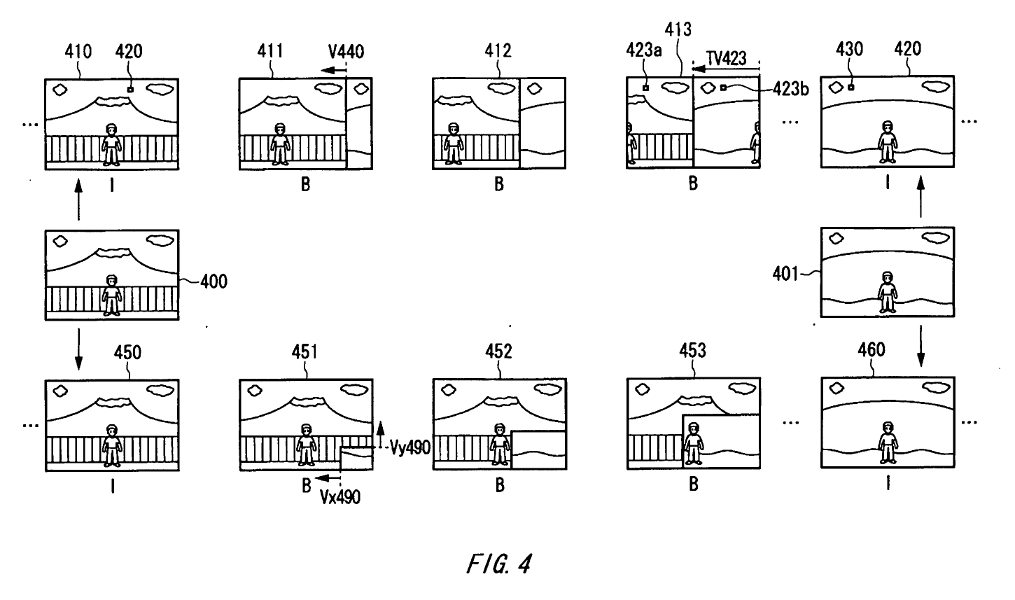

FIG. 4 is a drawing showing another exemplary transition of still images. The moving image generating section 214 generates moving images showing the transition of images. In concrete, the transition data obtaining section 212 obtains transition data representing a shift of the still images. In the example in FIG. 4, the transition data obtaining section 212 obtains transition data in which a still image 401 shifts from the right end by same velocity with a still image 400 that shifts toward the left end of a display area. In concrete, the transition data obtaining section 212 obtains the transition data that stipulates shift velocity V440 of a display boundary line between the still images 400 and 401. In the example of this figure, the moving image generating section 214 also generates the still images 400 and 401 as moving image composing images 410 and 420 (I pictures).

Then, the moving image generating section 214 calculates shift vector TV423 of a boundary line from position of the boundary line (right end of the display area in the example of the figure) in a moving image composing image 410 (I picture) by temporally integrating the velocity of the boundary line from timing when the moving image composing image 410 (I picture) is regenerated to each timing when each moving image composing image is regenerated. In this case, the image content of a macro-block 423a may be expressed by the shift vector TV423 of the boundary line and zero differential image signal by making reference to the moving image composing image 410 in the same manner with the connection between the object shift vector and motion vector in the shift of the object explained in FIG. 3. A macro-block 423b may be also expressed in the same manner by the shift vector TV423 of the boundary line and zero differential image signal by making reference to the moving image composing image 420 (I picture).

In another example of transition of images in the figure, the moving image generating section 214 also generates a moving image in which a region displaying the image content of the still image 401 expands from an under right corner toward an upper left corner in the moving image in which the display shifts from the still image 400 to the still image 401. In concrete, the moving image generating section 214 generates a still image 450 from the still image 400 as I picture and generates a moving image composing image 460 that is a next I picture from that I picture from the still image 401. More specifically, the transition data obtaining section 212 obtains transition data representing shift velocities Vx490 and Vy490 of display boundary lines respectively in X and Y directions. Macro-blocks containing no display boundary line among moving image composing images 451, 452 and 453 are all contained in moving image composing images of I picture before and after that in the moving image of this example. Accordingly, it is possible to judge that components of motion vector may be expressed by zero directly from the transition data in macro-blocks other than those containing the display boundary line by generating all moving image composing images as B picture.

It is noted that in either examples of transition of images described above, the image content of the macro-block containing the display boundary line may be readily composed from the image contents of the still images 400 and 401, the position of the boundary line and the position of the macro-block in the same manner with the method for composing the macro-block containing the boundary line in FIG. 3. The selection whether the difference from the still image 400 or from the still image 401 is adopted and the selection of the region where the difference is calculated may be calculated directly from the transition data also in expressing the image content of the macro-block by the difference from the I picture

Since the moving image generating apparatus 100 is capable of obtaining the motion vector and differential image signal directly from the shift vector of the boundary line as described above, it can remarkably reduce time for generating a moving image as compare to a case of implementing MPEG-coding after pixel data of moving image composing images is generated once. It is noted that although the case of generating the I picture in the moving image from one still image and object or from one still image in FIGS. 3 and 4 in order to simplify the explanation, it is needless to say that an image made by combining a plurality of still images may be generated as an I picture. Still more, the transition data obtaining section 212 may obtain transition data indicating of generating images made by combining a plurality of still images as moving image composing images.

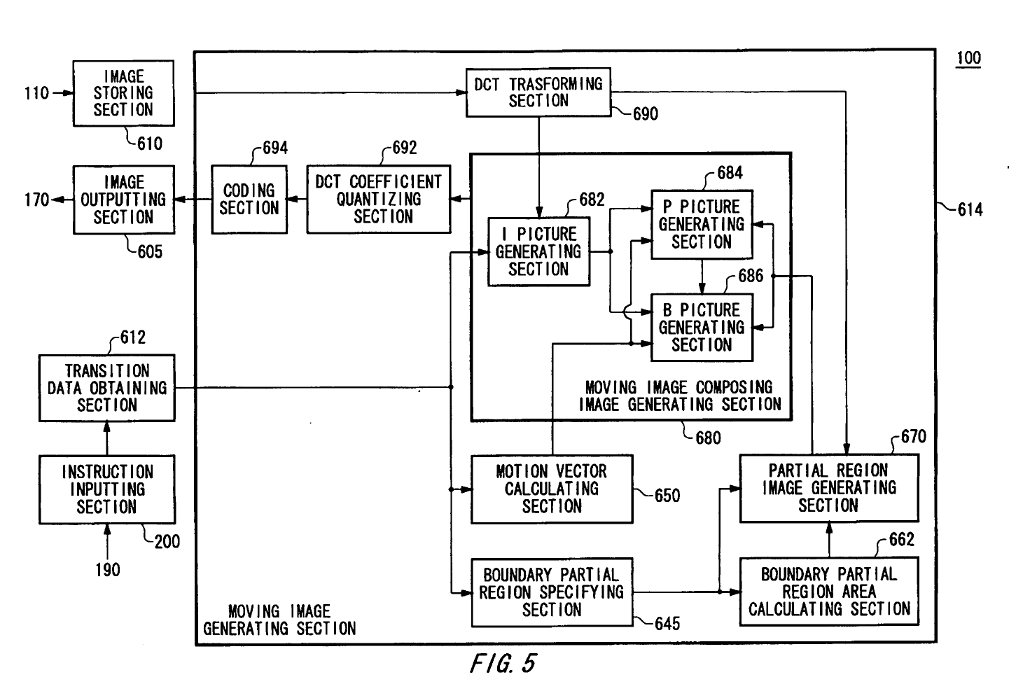

FIG. 5 is a block diagram showing one exemplary block configuration of the moving image generating apparatus 100 according to a second embodiment. The moving image generating apparatus 100 of the present embodiment aims at quickening the generation of images in the macro-blocks at the boundary part of the image in generating the moving image as explained in connection with FIGS. 2 through 4. In concrete, the moving image generating apparatus 100 of the present embodiment is characterized in generating a DCT coefficient in a macro-block containing a boundary part of a still image in a moving image composing image directly by adding DCT coefficients of macro-blocks containing the image contents of the boundary part in the still images. Accordingly, the speed for generating the moving image improves further by combining functions of the moving image generating apparatus 100 explained in the present embodiment into the functions of the moving image generating apparatus 100 in the first embodiment.

The moving image generating apparatus 100 of the present embodiment has an image storing section 610, a transition data obtaining section 612 and a moving image generating section 614. The moving image generating section 614 has a motion vector calculating section 650, a boundary partial region area calculating section 662, a boundary partial region area calculating section 262, a partial region image generating section 670, a moving image composing image generating section 680, a DCT transforming section 690, a the DCT coefficient quantizing section 692 and a coding section 694. The moving image composing image generating section 680 also includes an I picture generating section 682, a P picture generating section 684 and a B picture generating section 686.

The image storing section 610 stores a plurality of still images. Then, the transition data obtaining section 612 obtains transition data representing how to shift a boundary line between a first still image and a second still image stored in the image storing section 610 in the moving image. The moving image generating section 614 generates a plurality of moving image composing images out of the still images stored in the image storing section 610 to generate a moving image containing the plurality of generated moving image composing images based on the transition data obtained by the transition data obtaining section 612.

In concrete, the DCT transforming section 690 implements DCT transform on the first and second still images stored in the image storing section 610 to calculate a DCT coefficient of plurality of partial regions contained in the first and second still images. Then, the boundary partial region specifying section 645 specifies whether or not the plurality of preset partial regions contained in one moving image composing image crosses over the boundary line between the first and second still images stored in the image storing section 610 based on the transition data obtained by the transition data obtaining section 612. It is noted that the boundary partial region specifying section 645 can specify whether or not the partial region crosses over the boundary line between the first and second still images based on the shift of the first and second still images represented by the transition data for example in the same manner with the operation of the boundary partial region specifying section 245 explained in the first embodiment.

Then, the partial region image generating section 670 generates the DCT coefficient of the partial region judged by the boundary partial region specifying section 645 as crossing over the boundary line from the DCT coefficient calculated by the DCT transforming section 690 for a partial region within the first still image existing in the vicinity of the boundary line and the DCT coefficient calculated by the DCT transforming section 690 for a partial region within the second still image existing in the vicinity of the boundary line. Then, the moving image composing image generating section 680 generates a moving image composing image containing the DCT coefficient of the partial region generated by the partial region image generating section 670.

In concrete, the partial region image generating section 670 generates the DCT coefficient of the partial region judged by the boundary partial region specifying section 645 as crossing the boundary line by averaging the DCT coefficient of the partial region within the first still image existing in the vicinity of the boundary line and the DCT coefficient of the partial region within the second still image existing in the vicinity of the boundary line per frequency component. The partial region image generating section 670 may also generate the DCT coefficient of the partial region judged by the boundary partial region specifying section 645 as crossing over the boundary line by weighting and averaging the DCT coefficient of the partial region within the first still image existing in the vicinity of the boundary line and the DCT coefficient of the partial region within the second still image existing in the vicinity of the boundary line based on the transition data obtained by the transition data obtaining section 612. The transition data obtaining section 212 may also obtain transition data indicating whether the background or the object is weighted more at the boarder and may use this as data for weighted average.

It is noted that the partial region image generating section 670 may generate the DCT coefficient of the partial region within the first still image existing in the vicinity of the boundary line and the DCT coefficient of the partial region within the second still image existing in the vicinity of the boundary line by averaging by weight different for each of a plurality of succeeding moving image composing images in the moving image based on the transition data obtained by the transition data obtaining section 612 in calculating the DCT coefficient of the partial region judged by the boundary partial region specifying section 645 as crossing over the boundary line in each of the plurality of moving image composing images. Thereby, the moving image generating apparatus 100 may readily add such a visual effect to viewers of the moving image of gradually increasing a composite rate of the object with respect to the background as the object shifts more for example.

The boundary partial region area calculating section 662 calculates an area of the first still image contained in the partial region judged by the boundary partial region specifying section 645 as crossing over the boundary line based on the transition data obtained by the transition data obtaining section 612. Then, when the area of the first still image calculated by the boundary partial region area calculating section 662 is greater, the partial region image generating section 670 calculates the DCT coefficient of the partial region judged by the boundary partial region specifying section 645 as crossing over the boundary line by largely weighting the DCT coefficient of the partial region within the first still image. When a rate of the area of the first still image calculated by the boundary partial region area calculating section 662 to the partial region is greater for example, the partial region image generating section 670 calculates the DCT coefficient of the partial region judged by the boundary partial region specifying section 645 as crossing over the boundary line by largely weighting the DCT coefficient of the partial region within the first still image.

It is noted that the transition data obtaining section 612 may obtain the transition data representing the shift of the first still image stored in the image storing section 610 with respect to the second still image stored in the image storing section 610. Then, the boundary partial region specifying section 645 specifies whether or not the plurality of preset partial regions contained in one moving image composing image cross over the boundary line between the first and second still images stored in the image storing section 610 based on the transition data obtained by the transition data obtaining section 612 and representing the shift of the first still image. Then, the partial region image generating section 670 generates the DCT coefficient of the partial region judged by the boundary partial region specifying section 645 as crossing over the boundary line from the DCT coefficient of the partial region within the first still image existing in the vicinity of the boundary line and the DCT coefficient of the partial region within the second still image existing in the vicinity of the boundary line. In concrete, the partial region image generating section 670 generates the DCT coefficient of the partial region by averaging the DCT coefficient of the partial region within the first still image existing in the vicinity of the boundary line and the DCT coefficient of the partial region within the second still image existing in the vicinity of the boundary line per frequency component.

The motion vector calculating section 650 also calculates motion vector representing a positional difference between the partial region judged by the boundary partial region specifying section 645 as not crossing over the boundary line and the partial region having the image content identical with the partial region and contained in the still image stored in the image storing section 610 or in another moving image composing image based on the transition data obtained by the transition data obtaining section 612. For example, the motion vector calculating section 650 calculates the motion vector based on the transition data obtained by the transition data obtaining section 612 and representing the shift of the first still image with respect to the second still image. It is noted that the detail of the concrete operation of the motion vector calculating section 650 is the same with that of the motion vector calculating section 250 in the moving image generating apparatus 100 of the first embodiment, so that its explanation will be omitted here. Then, the moving image composing image generating section 680 generates moving image composing images containing the DCT coefficients of the partial region expressed by the motion vector calculated by the motion vector calculating section 650 and generated by the partial region image generating section 670.

It is noted that the moving image generating section 614 may generate a MPEG-coded moving image in which a plurality of still images stored in the image storing section 610 are shifted. In concrete, the boundary partial region specifying section 645 specifies whether or not a plurality of preset macro-blocks contained in one moving image composing image crosses over the boundary line between the first and second still images stored in the image storing section 610 based on the transition data obtained by the transition data obtaining section 612. Then, the partial region image generating section 670 generates the DCT coefficient of the macro-block judged by the boundary partial region specifying section 645 as crossing the boundary line by averaging the DCT coefficient of the macro-block within the first still image existing in the vicinity of the boundary line and the DCT coefficient of the macro-block within the second still image existing in the vicinity of the boundary line per frequency component.

Further, the motion vector calculating section 650 calculates motion vector representing a positional difference between the macro-block judged by the boundary partial region specifying section 645 as not crossing over the boundary line and the partial region having the image content identical with the macro-block and contained in the still image stored in the image storing section 610 or in the other moving image composing images based on the transition data obtained by the transition data obtaining section 612. Then, the moving image composing image generating section 680 generates moving image composing images containing the DCT coefficients of the macro-blocks expressed by the motion vector calculated by the motion vector calculating section 650 and the macro-blocks generated by the partial region image generating section 670.

In concrete, the I picture generating section 682 generates the moving image composing image as an I picture from the still image stored in the image storing section 610 based on the transition data obtained by the transition data obtaining section 612. The P picture generating section 684 also generates the moving image composing image as a P picture based on the transition data obtained by the transition data obtaining section 612 and the I picture generated by the I picture generating section 682. Then, the motion vector calculating section 650 calculates motion vector representing a optional difference between the macro-block judged by the boundary partial region specifying section 645 as not crossing over the boundary line and the partial region having the image content identical with the macro-block and contained in the I picture generated by the I picture generating section 682 based on the transition data obtained by the transition data obtaining section 612. Then, the P picture generating section 684 generates the moving image composing image containing the macro-block expressed by the motion vector calculated by the motion vector calculating section 650 as a P picture.

The B picture generating section 686 also generates the macro-block as a B picture based on the transition data obtained by the transition data obtaining section 612 and the I picture generated by the I picture generating section 682 or the P picture generated by the P picture generating section 684. Then, the motion vector calculating section 650 calculates motion vector representing a positional difference between the macro-block judged by the boundary partial region specifying section 645 as not crossing over the boundary line and the partial region having the image content identical with the macro-block and contained in the I picture generated by the I picture generating section 682 or the P picture generated by the P picture generating section 684. Then, the B picture generating section 686 generates the moving image composing image containing the macro-block expressed by the motion vector calculated by the motion vector calculating section 650 as a B picture.

The DCT coefficient quantizing section 292 generates a moving image composing image whose data amount is compressed by implementing quantization on the DCT coefficient contained in the moving image composing image generated as the I picture, P picture or B picture by the moving image composing image generating section 280. The coding section 294 generates a moving image containing the moving image composing images whose data amount has been compressed by implementing coding on the moving image composing images generated by the DCT coefficient quantizing section 292. The image outputting section 205 outputs the moving image containing the moving image composing images generated by the coding section 294 to the outside of the moving image generating apparatus 100. For example, the image outputting section 205 outputs the moving image to a recording medium such as a DVD.

As described above, the moving image generating apparatus 100 of the present embodiment can generate the moving image quickly as compared to the case of generating pixel data and implementing DCT transform because no DCT transform is implemented to generate P or B picture.

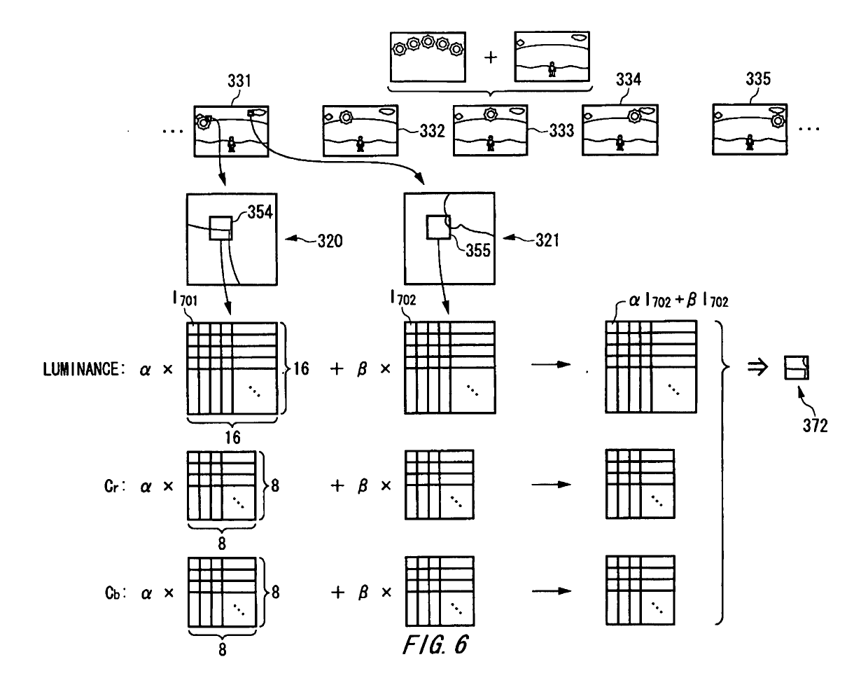

FIG. 6 is a drawing showing one exemplary process for calculating a DCT coefficient of a macro-block containing boundary lines. An example in this figure is same with the transition data explained in FIG. 3 except of the method for calculating the image data of the macro-block containing the boundary line, so that its explanation will be omitted here except of their difference.

The DCT transforming section 690 calculates a DCT coefficient by implementing the DCT transform on each macro-block contained in a moving image composing image 331 (I picture). In concrete, the DCT transforming section 690 calculates a luminance signal of a macro-block 354 having 16 pixels respectively in horizontal and vertical directions in the moving image composing image as a DCT coefficient per four blocks having eight pixels respectively in horizontal and vertical directions. The DCT transforming section 690 also calculates each of color difference signals of Cr and Cb respectively as a DCT coefficient of a block of 8 pixels respectively in horizontal and vertical direction in the macro-block 354. In the same manner, the DCT transforming section 690 calculates a DCT coefficient respectively in each block of a luminance signal and color difference signals of Cr and Cb in a macro-block 355 that is the background of the object.

Then, the DCT transforming section 690 calculates the DCT coefficients of the luminance signal and the color difference signals Cr and Cb of the macro-block by weight-averaging the DCT coefficient calculated for each block of the macro-blocks 354 and 355 per frequency component. It is noted that averaging of the DCT coefficient in each block of the luminance signal is averaging of DCT coefficients with a block at the same position as a matter of course. It is also needless to say that the DCT coefficient of a Cr signal of the macro-block 354 and the DCT coefficient of a Cr signal of the macro-block 355 are averaged and the DCT coefficient of a Cb signal of the block 354 and the DCT coefficient of a Cb signal of the block 355 are averaged. In this figure, an example of calculating DC components (α×1701+β×1702) of one block in a luminance signal of a macro-block 372 is shown by using weight coefficients α and β to each of the DC component 1701 of one block in the luminance signal of the macro-block 354 and the DC component 1702 of one block in the luminance signal of the macro-block 355.

The process described above allows the DCT coefficient of the image content of the macro-block containing the boundary section to be directly calculated by averaging the DCT coefficient calculated in advance. Accordingly, it is possible to generate a DCT coefficient of an image content of a macro-block containing a boundary part more quickly as compared to the case of implementing DCT transform from pixel data. An image obtained by averaging such DCT coefficient becomes an image in which a background is superimposed with an object, so that it is not an image in which the boundary part of the object and the background is accurately expressed in the image in which the object shifts on the background images for example. However, the images of the background and the object remain as a residual image around the shifting object for eyes of the viewer of the moving image, so that the moving object seems fuzzy. Therefore, even if the background is superimposed with the object in the image of the macro-block containing the contour of the object, the viewer can view the moving image without feeling sense of incompatibility.

It is noted that a positional difference in x and y directions between the object in the I picture and the object in the P or B picture desirably coincides with the size (16 pixels) of the macro-block. When the difference coincides, a part coincident with a part of the object and a part of the background contained in the macro-block containing a boundary line in P or B picture is contained in either macro-block in the I picture, so that the image content of the macro-block may be generated more accurately. When the difference does not coincide in contrary, the DCT coefficient may be averaged for a macro-block whose area coincident with the object contained in the macro-block containing the boundary line is the largest and a macro-block whose area coincident with the background contained in the macro-block containing the boundary line is the largest. The DCT coefficient representing the image content of macro-block crossing with the boundary line may be approximately calculated by averaging the DCT coefficients of the macro-blocks existing in the vicinity of the boundary line of the object and the background. Still more, it is possible to give the visual effect in the boundary part of the object by weighting by weight coefficients α and β in the average of the DCT coefficient. For example, a degree of stress of the object at the boundary may be changed by increasing weight (α) of the object in moving image composing images reproduced in a latter timing in a plurality of moving image composing images.

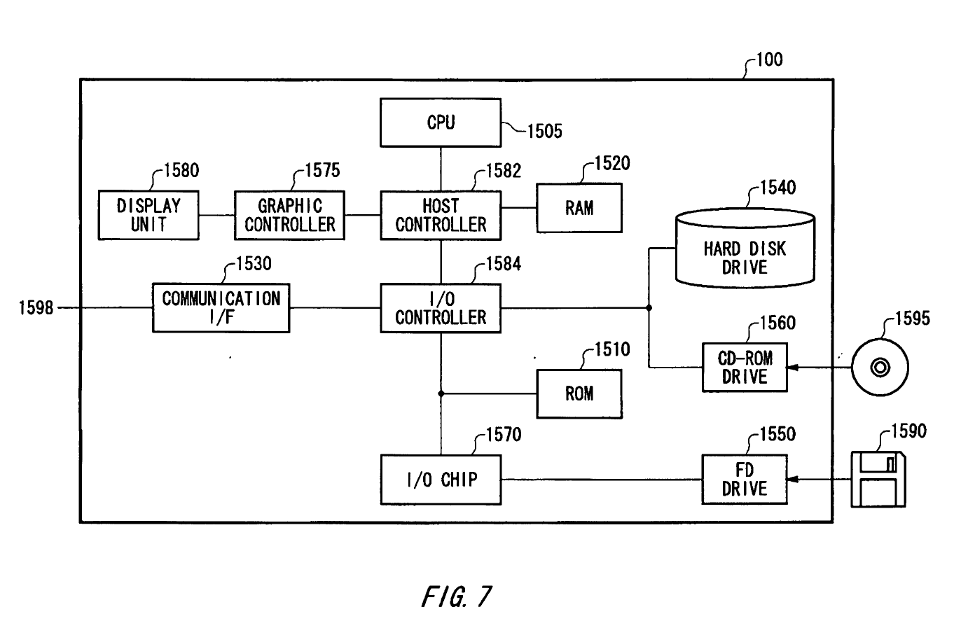

FIG. 7 is a block diagram showing one exemplary hardware configuration of the moving image generating apparatus 100 of the first and second embodiments. The moving image generating apparatus 100 comprises a CPU peripheral section having a CPU 1505, a RAM 1520, a graphic controller 1575 and a display device 1580 mutually connected by a host controller 1582, an input/output section having a communication interface 1530, a hard disk drive 1540 and a CD-ROM drive 1560 connected with the host controller 1582 via an input/output controller 1584 and a legacy input/output section having a ROM 1510, a flexible disk drive 1550 and an input/output chip 1570 connected with the input/output controller 1584.

The host controller 1582 connects the RAM 1520, the CPU 1505 that accesses the RAM 1520 at high transfer rate and the graphic controller 1575. The CPU 1505 operates based on programs stored in the ROM 1510 and the RAM 1520 to control the respective sections. The graphic controller 1575 obtains image data generated by the CPU 1505 and others on a frame buffer provided within the RAM 1520 to display on the display device 1580. Instead of that, the graphic controller 1575 may contain the frame buffer for storing the image data generated by the CPU 1505 and others.

The input/output controller 1584 connects the host controller 1582 with the communication interface 1530, which is a relatively fast input/output device, the hard disk drive 1540 and the CD-ROM drive 1560. The hard disk drive 1540 stores programs and data used by the CPU 1505. The communication interface 1530 is connected with the network communication unit 1598 to transmit/receive a program or data. The CD-ROM drive 1560 reads the program or data out of the CD-ROM 1595 and provides it to the hard disk drive 1540 and to the communication interface 1530 via the RAM 1520.

The input/output controller 1584 is connected with the relatively slow input/output devices of the ROM 1510, the flexible disk drive 1550 and the input/output chip 1570. The ROM 1510 stores a boot program executed by the moving image generating apparatus 100 in starting the system and programs and the like dependent on the hardware of the moving image generating apparatus 100. The flexible disk drive 1550 reads a program or data out of a flexible disk 1590 and provides it to the hard disk drive 1540 and to the communication interface 1530 via the RAM 1520. The input/output chip 1570 connects the flexible disk drive 1550 with the various input/output devices via parallel ports, serial ports, keyboard ports, mouse ports and the like.

The program executed by the CPU 1505 is stored in a recording medium such as the flexible disk 1590, the CD-ROM 1595 and an IC card and is given by the user. The program stored in the recording medium may be compressed or non-compressed. The program is installed in the hard disk drive 1540 from the recording medium, is read by the RAM 1520 and is executed by the CPU 1505.

The program executed by the CPU 1505 operates the moving image generating apparatus 100 in the first embodiment as the instruction inputting section 200, the image outputting section 205, the image storing section 210, the transition data obtaining section 212 and the moving image generating section 214 explained in FIGS. 1 through 4. The program also operates the moving image generating section 214 as the object shift vector calculating section 220, the regional shift vector calculating section 225, the object position specifying section 230, the identical partial region specifying section 240, the motion vector calculating section 250, the resembling partial region specifying section 260, the partial region image generating section 270, the moving image composing image generating section 280, the DCT transforming section 290, the DCT coefficient quantizing section 292 and the coding section 294. The program also operates the resembling partial region specifying section 260 as the boundary partial region area calculating section 262 and the resembling partial region selecting section 264 and operates the identical partial region specifying section 240 as the boundary partial region specifying section 245. The program also operates the moving image composing image generating section 280 as the I picture generating section 282, the P picture generating section 284 and the B picture generating section 286. The program executed by the CPU 1505 also operates the moving image generating apparatus 100 in the second embodiment as the instruction inputting section 600, the image outputting section 605, the image storing section 610, the transition data obtaining section 612 and the moving image generating section 614 explained in connection with FIGS. 1, 5 and 6. The program also operates the moving image generating section 614 as the motion vector calculating section 650, the boundary partial region area calculating section 662, the boundary partial region area calculating section 262, the partial region image generating section 670, the moving image composing image generating section 280, the DCT transforming section 690, the DCT coefficient quantizing section 692 and the coding section 694. The program further operates the moving image composing image generating section 680 as the I picture generating section 682, the P picture generating section 684 and the B picture generating section 686.

The programs described above may be stored in the outside storage medium. Beside the flexible disk 1590 and the CD-ROM 1595, the storage medium may be an optical recording medium such as DVD and PD, a magneto-optical recording medium such as MD, a taped medium and a semiconductor memory such as an IC card. Still more, a storage unit such as a hard disk and RAM provided in a server system connected with a dedicated communication network and Internet may be used as a recording medium and the programs may be provided to the moving image generating apparatus 100 through such network.

Although the invention has been described by way of the exemplary embodiments, it should be understood that those skilled in the art might make many changes and substitutions without departing from the spirit and scope of the invention.

It is obvious from the definition of the appended claims that the embodiments with such modifications also belong to the scope of the invention.

What is claimed is:

1. A moving image generating apparatus for generating a moving image in which a plurality of still images are shifted, comprising:
a transition data obtaining section for obtaining transition data representing how to shift the plurality of still images; and
a moving image generating section for generating a plurality of moving image composing images from the still images based on the transition data obtained by said transition data obtaining section to generate the moving image containing the plurality of generated moving image composing images; and
wherein said moving image generating section comprises:
an identical partial region specifying section for specifying whether or not a partial region having image content identical with each one of a plurality of preset partial regions contained in one moving image composing image exists in the still image or in another moving image composing image based on the transition data obtained by said transition data obtaining section;
a motion vector calculating section for calculating motion vector representing positional difference between the partial region judged by said identical partial region specifying section as containing the partial region having the identical image content and the partial region having the image content identical with the partial region and contained in the still image or the other moving image composing image based on the transition data obtained by said transition data obtaining section; and
a moving image composing image generating section for generating the moving image composing image containing the partial region expressed by the motion vector calculated by said motion vector calculating section.

2. The moving image generating apparatus as set forth in claim 1, wherein
said moving image generating section further includes a partial region image generating section for generating the image content of the partial region judged by said identical partial region specifying section as containing no partial image having the identical image content from the still image or the other moving image composing image based on the transition data obtained by said transition data obtaining section; and
said moving image composing image generating section generates the moving image composing image containing the image contents of the partial region expressed by the motion vector calculated by said motion vector calculating section and of the partial region generated by said partial region image generating section.

3. The moving image generating apparatus as set forth in claim 2, wherein said transition data obtaining section obtains transition data representing at least part of shift region of the still image;
said moving image generating section further includes a regional shift vector calculating section for calculating regional shift vector representing a positional difference between position of a shift region in one moving image composing image and position of a shift region in the still image or in another moving image composing image based on the transition data obtained by said transition data obtaining section and representing the shift of the shift region;
said identical partial region specifying section specifies whether or not the partial region having image content identical with each partial region whose whole range is contained in the shift region among the plurality of preset partial regions contained in one moving image composing image exists in the still images or in the other moving image composing images based on the regional shift vector calculated by said regional shift vector calculating section; and
said motion vector calculation calculates the regional shift vector calculated by said regional shift vector calculating section as a positional difference between the partial region judged by said identical partial region specifying section as containing a partial region having the identical image content and the partial region having the image content identical with the partial region and contained in the still images or the other moving image composing images as motion vector.

4. The moving image generating apparatus as set forth in claim 2, wherein said transition data obtaining section obtains transition data representing a shift of an object shifting on a background of still images or other moving image composing images;
said moving image generating section further includes an object shift vector calculating section for calculating an object shift vector representing a positional difference between position of the object in one moving image composing image and position of the object in the still image or in the other moving image composing image based on the transition data obtained by said transition data obtaining section and representing the shift of the object;
said identical partial region specifying section specifies whether or not a partial region having image content identical with each partial region whose whole range is contained in the object among a plurality of preset partial regions contained in one moving image composing image exists in the still image or the other moving image composing image based on the object shift vector calculated by said object shift vector calculating section; and
said motion vector calculating section calculates the object shift vector calculated by said object shift vector calculating section as motion vector representing a positional difference between the partial region judged by said identical partial region specifying section as containing the partial region of the identical image content and the partial region contained in the still image or the other moving image composing image.

5. The moving image generating apparatus as set forth in claim 4, wherein said identical partial region specifying section specifies whether or not a partial region having image content identical with each partial region whose whole rage is contained in the background on which the object shifts among a plurality of preset partial regions contained in one moving image composing image exists in the still image or in the other moving image composing image based on the object shift vector calculated by said object shift vector calculating section; and
said motion vector calculating section zeros the motion vector of the partial region specified by said identical partial region specifying section as containing the partial region having the identical image content.

6. The moving image generating apparatus as set forth in claim 4, wherein said transition data obtaining section obtains transition data representing temporal changes of a value of shift and shift direction of the object shifting on the background of the still image or the other moving image composing image; and
said object shift vector calculating section calculates object shift vector representing a positional difference of the object between one moving image composing image and the other moving image composing image by temporally integrating the temporal changes of the value of shift and shift direction of the object contained in the transition data obtained by said transition data obtaining section.

7. The moving image generating apparatus as set forth in claim 1, wherein said moving image generating section generates a MPEG-coded moving image in which a plurality of still images are shifted;
said identical partial region specifying section specifies whether or not a partial region having image content identical with each of a plurality of preset macro-blocks contained in one moving image composing image exists in the still image or the other moving image composing images based on the transition data obtained by said transition data obtaining section;
said motion vector calculating section calculates motion vector representing a positional difference between the macro-block judged by said identical partial region specifying section as containing the partial region of the identical partial region and the partial region having the image content identical with the macro-block and contained in the still image or in the other moving image composing image based on the transition data obtained by said id obtaining section; and
said moving image composing image generating section generates a MPEG-coded moving image composing image containing the macro-block expressed by the motion vector calculated by said motion vector calculating section.

8. The moving image generating apparatus as set forth in claim 7, wherein said moving image composing image generating section includes:
an I picture generating section for generating moving image composing images as I pictures from the still images based on transition data obtained by said transition data obtaining section; and
a P picture generating section for generating moving image composing images as P pictures based on the transition data obtained by said transition data obtaining section and on the I pictures generated by said I picture generating section;
said identical partial region specifying section specifies whether or not a partial region having image content identical with each of a plurality of preset macro-blocks contained in one moving image composing image exists in the I picture generated by said I picture generating section based on the id obtained by said transition data obtaining section;
said motion vector calculating section calculates motion vector representing a positional difference between the macro-block judged by said identical partial region specifying section as containing a partial region having the identical image content and a partial region having the mc identical with said macro-block and contained in the I picture generated by said I picture generating section based on the transition data obtained by said transition data obtaining section; and
said P picture generating section generates the moving image composing image containing the macro-block expressed by the motion vector calculated by said motion vector calculating section as a P picture.

9. The moving image generating apparatus as set forth in claim 8, wherein said moving image composing image generating section further includes:
a B picture generating section for generating moving image composing images as B pictures based on the transition data obtained by said transition data obtaining section, the I picture generated by said I picture generating section or the P picture generated by said P picture generating section;
said identical partial region specifying section specifies whether or not a partial region having image content identical with each of a plurality of preset macro-blocks contained in one moving image composing image exists in the I picture generated by said I picture generating section or in the P picture generated by said P picture generating section;
said motion vector calculating section calculates motion vector representing a positional difference between the macro-block judged by said Identical partial region specifying section as containing the partial region of the identical image content and the partial region having the image content identical with the macro-block and contained in the I picture generated by said I picture generating section or the P picture generated by said P picture generating section based on the transition data obtained by said transition data obtaining section; and
said B picture generating section generates the moving image composing image containing the macro-block expressed by the motion vector calculated by said motion vector calculating section as the B picture.

10. The moving image generating apparatus as set forth in claim 9, wherein said transition data obtaining section obtains transition data representing an shift of an object shifting on a background of still images or other moving image composing images;
said moving image generating section further includes an object shift vector calculating section for calculating object shift vector representing a positional difference between position of the object in the moving image composing image to be generated as a P picture and position of the object in the I picture generated by said I picture generating section based on the transition data obtained by said transition data obtaining section and representing the shift of the object;
said Identical partial region specifying section specifies whether or not the partial region having the image content identical with each of macro-blocks whose whole range is contained in the object among the plurality of macro-blocks contained in the moving image composing image to be generated as the P picture exists in the I picture generated by said I picture generating section based on the object shift vector calculated by said object shift vector calculating section;
said motion vector calculating section calculates the object shift vector calculated by said object shift vector calculating section as motion vector representing a positional difference between the macro-block judged by said Identical partial region specifying section as containing the partial region of the identical image content and the partial region having the image content identical with the macro-block and contained in the I picture generated by said I picture generating section; and
said P picture generating section generates the moving image composing image containing the macro-block expressed as the motion vector calculated by said motion vector calculating section as the P picture.

11. The moving image generating apparatus as set forth in claim 10, wherein said object shift vector calculating section calculates object shift vector representing a positional difference between position of the object in the moving image composing image to be generated as a B picture and position of the object in the I picture generated by said I picture generating section or in the P picture generated by said P picture generating section based on the transition data obtained by said transition data obtaining section and representing the shift of the object;
said Identical partial region specifying section specifies whether or not the partial region having the image content identical with each of macro-blocks whose whole range is contained in the object among a plurality of macro-blocks contained in the moving image composing image to be generated as a B picture exists in the I picture generated by said I picture generating section or in the P picture generated by said P picture generating section based on the object shift vector calculated by said object shift vector calculating section;
said motion vector calculating section calculates the object shift vector calculated by said object shift vector calculating section as motion vector representing a positional difference between the macro-block judged by said Identical partial region specifying section as containing the partial region of the identical image content and the partial region having the image content identical with the macro-block and contained in the I picture generated by said I picture generating section or in the P picture generated by said P picture generating section; and
said B picture generating section generates the moving image composing image containing the macro-block expressed by the motion vector calculated by said motion vector calculating section as a B picture.

12. A moving image generating method for generating a moving image in which a plurality of still images are shifted, comprising:
a transition data obtaining step of obtaining transition data representing how to shift the plurality of still images; and
a moving image generating step of generating a plurality of moving image composing images from the still images based on the transition data obtained in said transition data obtaining step to generate the moving image containing the plurality of generated moving image composing images;
wherein said moving image generating step comprises:
an identical partial region specifying step of specifying whether or not a partial region having image content identical with each one of a plurality of preset partial regions contained in one moving image composing image exists in the still image or in another moving image composing image based on the transition data obtained in said transition data obtaining step;
a motion vector calculating step of calculating motion vector representing positional difference between the partial region judged in said identical partial region specifying step as containing the partial region having the identical image content and the partial region having the image content identical with the partial region and contained in the still image or the other moving image composing image based on the transition data obtained in said transition data obtaining step; and
a moving image composing image generating step of generating the moving image composing image containing the partial region expressed by the motion vector calculated in said motion vector calculating step.

13. A program for a moving image generating apparatus for generating a moving image in which a plurality of still images are shifted and operating said moving image generating apparatus as:
a transition data obtaining section for obtaining transition data representing how to shift the plurality of still images; and
a moving image generating section for generating a plurality of moving image composing images from the still images based on the transition data obtained by said transition data obtaining section to generate the moving image containing the plurality of generated moving image composing images; and
perating said moving image generating section as:
an identical partial region specifying section for specifying whether or not a partial region having image content identical with each one of a plurality of preset partial regions contained in one moving image composing image exists in the still image or in another moving image composing image based on the transition data obtained by said transition data obtaining section;
a motion vector calculating section for calculating motion vector representing positional difference between the partial region judged by said identical partial region specifying section as containing the partial region having the identical image content and the partial region having the image content identical with the partial region and contained in the still image or the other moving image composing image based on the transition data obtained by said transition data obtaining section; and
a moving image composing image generating section for generating the moving image composing image containing the partial region expressed by the motion vector calculated by said motion vector calculating section.
